(19) United States
(12) Patent Application Publication
(10) Pub. No.: US 2016/0210521 A1
(43) Pub. Date: Jul. 21, 2016

(54) METHOD FOR DETECTING ERRORS

(71) Applicant: FTS COMPUTERTECHNIK GMBH, Wien (AT)

(72) Inventor: Stefan Traxler, Wien (AT)

(21) Appl. No.: 14/913,049

(22) PCT Filed: Aug. 13, 2014
(86) PCT No.: PCT/AT2014/050176

§ 371 Date: Feb. 19, 2016

(30) Foreign Application Priority Data
Aug. 20, 2013 (AT) A50516/2013

(51) Int. Cl. G06K 9/03; G06K 9/00

(52) U.S. Cl. CPC G06K 9/03; G06K 9/00805

(57) ABSTRACT

A method for error detection for at least one system (1), characterised by a) at least partially optically measuring at least one system variable S1 at least at one moment in time t1 or at least in a time interval Δt1, b) creating at least one prediction value Px for at least one system variable Sx for at least one moment in time t2 following the moment in time t1 or for at least one time interval Δt2 following the time interval Δt1 with the aid of the at least one computing model (4), c) comparing the at least one prediction value Px with at least one value of the at least one system variable Sx associated with the moment in time t2 or the time interval Δt2, and d) using the result of the comparison of step c) to determine the presence of at least one error.

The invention relates to a method for error detection for at least one system.

The invention also relates to an error detection device for at least one system, wherein at least one sensor is configured for the optical measurement of least one system variable S1 at least at one moment in time t1 or at least in a time interval Δt1. A further aspect of the invention relates to a vehicle having at least one error detection device according to the invention.

Systems of the type mentioned in the introduction can be characterised for example with the aid of input variables, state variables and output variables, which may be accessible by means of a direct or indirect measurement or a monitoring (or a calculation). In particular, technical systems in which at least one system variable can be optically measured are conceivable systems of this type. Input variables, state variables, output variables and/or variables that lie within the perception or detection range of the system can be considered as system variables.

Optical/visual measuring or monitoring devices for detecting object movements are already known from the prior art. Depending on the application of these measuring or monitoring devices, different requirements are placed on the accuracy and reliability of the measuring or monitoring devices. For error detection of incorrect measurement and/or calculation results, redundant measuring or monitoring devices and/or calculation algorithms are often provided, with the aid of which the measurement and/or calculation results can be verified or falsified.

A visual monitoring device of this type is disclosed for example in DE 10 2007 025 373 B3, which can record image data comprising first distance information and can identify and track objects from the image data. This first distance information is checked for plausibility on the basis of second distance information, wherein the second distance information is obtained from a change of an image size of the objects over successive sets of the image data. The first distance information to be checked is therefore compared with newer information obtained at a later moment in time and is thus checked for plausibility. The newer (second) distance information must therefore first be input in order to check the first distance information. An immediate checking of the first distance information is not possible. In addition, it is not possible to determine whether errors of the first distance information are contained similarly in the second distance information. A comparison of the two distance information items in such a scenario would not show any deviations and would indicate the plausibility of the data, although both distance information items would in fact be defective. This risk is increased in particular when both distance information items are obtained with the aid of the same image sensor of the monitoring device. In addition, this monitoring device is configured merely for the capture and checking of distance information and does not provide any checking of other information.

The object of the invention is therefore to create an error detection for at least one motor vehicle system, which error detection is performed reliably, using little processing power, and also independently or redundantly where possible, and can be implemented economi-cally and allows a comprehensive checking of a multiplicity of system variables.

In a first aspect of the invention this object is achieved with a method of the type described in the introduction, in which the following steps are provided in accordance with the invention:

a) at least partially optically measuring at least one system variable S1 at least at one moment in time t1 or at least in a time interval Δt1,
b) processing at least the optical measurement performed in step a) in at least one computing model,
c) creating at least one prediction value Px for at least one system variable Sx for at least one moment in time t2 following the moment in time t1 or for at least one time interval Δt2 following the time interval Δt1 with the aid of the at least one computing model,
d) comparing the at least one prediction value Px with at least one value of the at least one system variable Sx associated with the moment in time t2 or the time interval Δt2, and
e) using the result of the comparison of step d) to determine the presence of at least one error.

Thanks to the method according to the invention, it is possible to reliably check a multiplicity of system variables using little processing power. The use of a computing model to create at least one prediction value, preferably a plurality of prediction values, here ena-bles a particularly quick verification or falsification of individual system variables. Suitable computing models can be implemented with very low computing effort and can run where appropriate on existing hardware (for example processors which are already used in vehicles or other systems to be checked). In addition, the redundancy of captured information can be increased. Generally, any information or system variables that can be derived from the system variable S1, the system variables Sx and/or the prediction values Px and the courses thereof over time can be obtained by the method according to the invention. Any variables that can be technically captured (can be measured or can be calculated) can generally be considered as system variables. Examples include the value and/or direction of physical variables or location information or orientation information relating to objects or object features. The presence of an error of the at least one system variable Sx can be detected by a comparison with the least one prediction value Px. For this purpose, the deviation of a system variable Sx from the prediction value Px is captured and for example compared with a predefinable threshold value, wherein, if this threshold value is exceeded, the presence of an error is concluded and an error signal can be output. Possible time intervals Δt1, Δt2 or time periods between the moments in time t1 and t2 may be, for example, between 0 and 10 ms, 10 and 50 ms, 50 and 100 ms, 100 and 1000 ms or 0 and 1 s or more.

In accordance with an advantageous embodiment of the method according to the invention, after step a) and before step b), the optical measurement performed in step a) can be processed in the least one computing model or in at least one further computing model. Conclusions can thus be drawn in a simple manner with regard to other variables, for example system variables Sx. The at least one further computing model may differ here from the computing model used in step b).

In a further development of the method according to the invention the at least one value of the at least one system variable Sx associated with the moment in time t2 or the time interval Δt2 can be determined in step d) by a measurement. The measurement of the at least one system variable Sx can be performed directly or indirectly, for example. In addition, a measurement of a plurality of system variables Sx is also possible. Measured values associated with the system variables Sx and which for example are captured in any case by the system to be checked can thus be verified or falsified in a simple manner.

Furthermore, individual system variables can also be captured by a calculation. In a favourable embodiment of the method according to the invention the least one value of the at least one system variable Sx associated with the moment in time t2 or the time interval Δt2 is determined in step d) by a calculation. A plurality of system variables Sx can also preferably be calculated. This allows a particularly economical implementation of the method according to the invention when the use of measuring devices can be reduced as a result. If the scope of measuring devices is retained, the calculations of the system variables Sx can be used additionally to check the validity of the system variables Sx.

In a particularly simple variant of the method according to the invention the at least one system variable Sx may comprise the system variable S1.

Alternatively or additionally, the at least one system variable Sx may comprise a system variable S2 different from the system variable S1. A multiplicity of system variables Sx is preferably checked by the method according to the invention. The method thus can be used in a particularly comprehensive and versatile manner.

In order to further increase the usability of the method according to the invention, the at least one system variable Sx may comprise a position variable, an orientation variable, colour information, contrast and/or sharpness information (local and/or global), a speed variable, an acceleration variable and/or a pressure variable.

In a particularly efficient implementation of the method according to the invention a series of images may be generated in step a) or b), from which relevant image features can be extracted by means of image processing algorithms, with the aid of which image features the at least one system variable Sx can be captured and/or predicted. The term “image processing algorithms” does not necessarily signify a plurality of algorithms. It is essential that relevant image features are captured and extracted with the aid of image processing. This can be implemented for example via filter functions. Such relevant image features can be found for example by gradient formation (for example in horizontal and/or vertical direction), whereby for example edges and/or corners depicted in the images can be detected. Information concerning the movement and concerning the spatial position of the individual features can be obtained from a chronological series of these relevant features. This technique is known by the expression “Structure from Motion.

Alternatively or as a development hereof, images may be generated in step a) or b) from different perspectives, from which relevant image features are extracted by means of image processing algorithms, with the aid of which image features the at least one system variable Sx is captured and/or predicted. Images from different perspectives can be created on the one hand by a chronological series of images in conjunction with a temporal change of the relative positions of the device capturing the images with respect to the surroundings to be depicted. On the other hand, it is possible to simultaneously record images by at least two devices capturing the images and to generate depth information by a comparison of the images from different perspectives. Here, a simultaneous recording from different perspectives provides the advantage of making depth information accessible particularly quickly, since there is no need to wait for a chronological series of the images. In addition, a relative movement of the surroundings with respect to the devices are capturing the images is not necessary. This technology is known by the term “Stereo 3D”.

In a particularly favourable embodiment of the method according to the invention coordinates of relevant image features can be extracted from the images by means of image processing algorithms and the at least one system variable Sx is captured and/or predicted with the aid of the temporal course of these coordinates. By way of example, movements of objects having relevant image features can thus be captured and evaluated. A system variable Sx could represent the position and/or the movement of a pedestrian moving towards a parking space in which a vehicle for example (which is considered by way of example as a system) is going to park automatically. The movements of the pedestrian are subject to physical limits. Certain temporal rates of change of the captured system variable “position and/or movement of the pedestrian” can therefore be ruled out. If, for example, a camera system mounted on the vehicle should identify the pedestrian, but erratically output or completely lose the position/movement of the pedestrian, this information can be checked and, in the absence of plausibility, a parking process can be interrupted.

The use of coordinates of relevant image features for the capture/prediction of the at least one system variable Sx can of course also be used advantageously in conjunction with a chronological series of images in accordance with a development of the method. In accordance with one development of the method, a series of images is thus generated in step a) or b), from which coordinates of relevant image features are extracted by means of image processing algorithms, and the at least one system variable Sx is captured and/or predicted with the aid of the temporal course of these coordinates. The term “capture” within the scope of this application may mean both a “measuring” and a “calculation”. Individual (3D) points of objects can also be captured as relevant image features. This is advantageous in particular for the detection of relative movements of individual objects relative to one another, since the concealment of individual points indicates the existence of a further object, possibly not detected previously.

In accordance with a particularly robust and quickly responsive embodiment of the method according to the invention, in step a) the measurement is performed with the aid of at least two, and preferably precisely two mutually distanced optical sensors.

In order to avoid entering into dangerous system states, an error routine can be triggered in an advantageous embodiment of the method with the presence of at least one error. An error routine of this type for example may cause a process to be stopped, for example the stopping of a parking process of a self-parking vehicle. Any expedient error routines can be defined in general.

As already indicated in the previous examples, the method according to the invention can be used particularly effectively when the system is a vehicle, in particular a motor vehicle. The development of vehicles and the increasingly widespread use of sensors and also of devices that autonomously perform vehicle functions places high demands on the safety and reliability of captured vehicle information, which can be assured particularly efficient-ly and easily with the method according to the invention.

In accordance with a development of the method the computing model may be a vehicle computing model. In a vehicle computing model the driving behaviour of vehicles is preferably mapped in a model-like manner, whereby information concerning system variables Sx or prediction values Px can be provided with the aid of system variables Sx or prediction values Px. In addition, additional computing models can be applied in order to model the vehicle surroundings.

In particular, the vehicle computing model may be a one-track model or a two-track model. By way of example, a linear one-track model is known from in chapter XVIII of the fourth edition of the work “Dynamik der Kraftfahrzeuge” (“Motor Vehicle Dynam-ics”) published by Springer (ISBN 3-540-42011-8) and written by Manfred Mitschke and Henning Wallentowitz, and a more complex two-track model designed for dynamic processes is known from chapter XXI and are particularly well suited as a vehicle computing models. In addition, what is known as a “1g model” can be provided, which, as a test criterion for movement changes, allows a maximum acceleration amounting to gravita-tional acceleration (9.81 m/s²).

In a second aspect of the invention the above-stated problem is achieved with an error detection device of the type mentioned in the introduction, wherein
at least one computing device is configured to process at least the optical measurement performed in at least one computing model, and
to create at least one prediction value Px for at least one system variable Sx for at least one moment in time t2 following the moment in time t1 or for at least one time interval Δt2 following the time interval Δt1 with the aid of the at least one computing model, wherein
the at least one computing device or at least one comparison device is configured to compare the at least one prediction value Px with at least one value of the at least one system variable Sx associated with the moment in time t2 or the time interval Δt2, and
the at least one computing device or the at least one comparison device uses the result of the comparison of to determine the presence of at least one error.

The computing device has at least one computing unit. It may also consist of a group of computing units, which can be arranged jointly or also separately from one another. Optical sensors used for the optical measurement may be any sensors that allow an optical measurement of the at least one system variable S1.

In accordance with an advantageous embodiment of the invention the at least one computing device, in order to process at least the optical measurement performed, additionally processes the optical measurement in the at least one computing model or in a further at least one computing model. It is therefore possible in a simple manner to come to a con-clusion regarding other variables, for example system variables Sx. The computing models may differ from one another here.

In a development of the error detection device according to the invention at least one measuring device may measure the at least one value of the at least one system variable Sx associated with the moment in time t2 or the time interval Δt2. The at least one system variable Sx can be measured for example directly or indirectly. In addition, a measurement of a plurality of system variables Sx is possible. Measured values associated with the system variables Sx and which for example are captured in any case by the system to be checked can thus be verified or falsified in a simple manner. The measuring device by way of example may have an optical sensor and/or any further sensors suitable for measuring the at least one system variable Sx.

Furthermore, individual system variables can also be captured by a calculation. In a favourable embodiment of the error detection device according to the invention the at least one computing device calculates the least one value of the at least one system variable Sx associated with the moment in time t2 or the time interval Δt2. A plurality of system variables Sx can also preferably be calculated. This allows a particularly economical implementation of the error detection system according to the invention, in particular when the use of measuring devices can be reduced as a result. If the scope of existing measuring devices is retained, the calculations of the system variables Sx can be used additionally to check the validity of the system variables Sx.

In a particularly simple variant of the error detection device according to the invention the at least one system variable Sx may comprise the system variable S1.

Alternatively or additionally, the at least one system variable Sx may comprise a system variable S2 different from the system variable S1. A multiplicity of system variables Sx are preferably checked by the error detection device according to the invention. The error detection device thus can be used in a particularly comprehensive and versatile manner.

In order to further increase the usability of the error detection device according to the invention, the at least one system variable Sx may comprise a position variable, an orientation variable, colour information (or local contrast information or local image sharpness information, a speed variable, an acceleration variable, contrast and/or sharpness information and/or a pressure variable.

In a particularly efficient implementation of the error detection device according to the invention the at least one computing unit may generate a series of images, extract relevant image features by means of image processing algorithms, and capture and/or predict the at least one system variable Sx with the aid of the image features.

Alternatively or as a development hereof, the at least one computing unit may generate images from different perspectives, extract relevant image features by means of image processing algorithms, and capture and/or predict the at least one system variable Sx with the aid of the image features.

In a particularly favourable embodiment of the method according to the invention the at least one computing unit can extract coordinates of relevant image features from the images by means of image processing algorithms and can capture and/or predict the at least one system variable Sx with the aid of the temporal course of these coordinates.

The use of coordinates of relevant image features for the capture/prediction of the at least one system variable Sx can of course also be used advantageously in conjunction with a chronological series of images in accordance with a development of the error detection device. In accordance with one development of the error detection device, at least one computing unit thus generates a series of images, extracts coordinates of relevant image features by means of image processing algorithms, and captures and/or predicts the at least one system variable Sx with the aid of the temporal course of these coordinates.

In accordance with a particularly robust and quickly responsive embodiment of the method according to the invention the error detection device may have at least two mutually distanced optical sensors.

The error detection device according to the invention can be used particularly effectively when the system is a vehicle, in particular a motor vehicle.

In accordance with a development of the error detection device, the computing model may be a vehicle computing model. In a vehicle computing model the driving behaviour of vehicles is preferably mapped in a model-like manner, whereby, with the aid of system variables Sx or prediction values Px, information can be provided concerning system variables Sx or prediction values Px. In addition, additional computing models can be applied in order to model the vehicle surroundings.

In particular, the vehicle computing model may be a one-track model or a two-track model.

In a third aspect of the invention a vehicle, in particular a motor vehicle, has at least one error detection device according to the invention.

The invention together with further embodiments and advantages will be explained in greater detail hereinafter on the basis of an exemplary non-limiting embodiment illustrated in the figures, in which

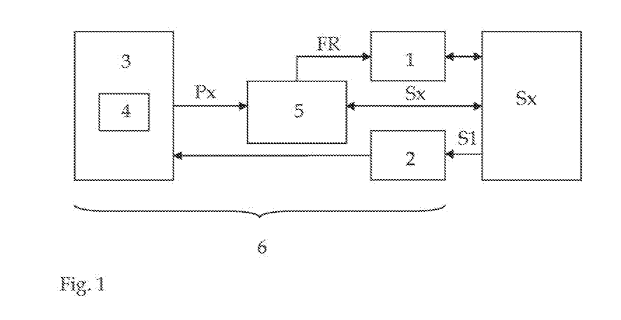

FIG. 1 shows a schematic block diagram of an error detection device according to the invention, and

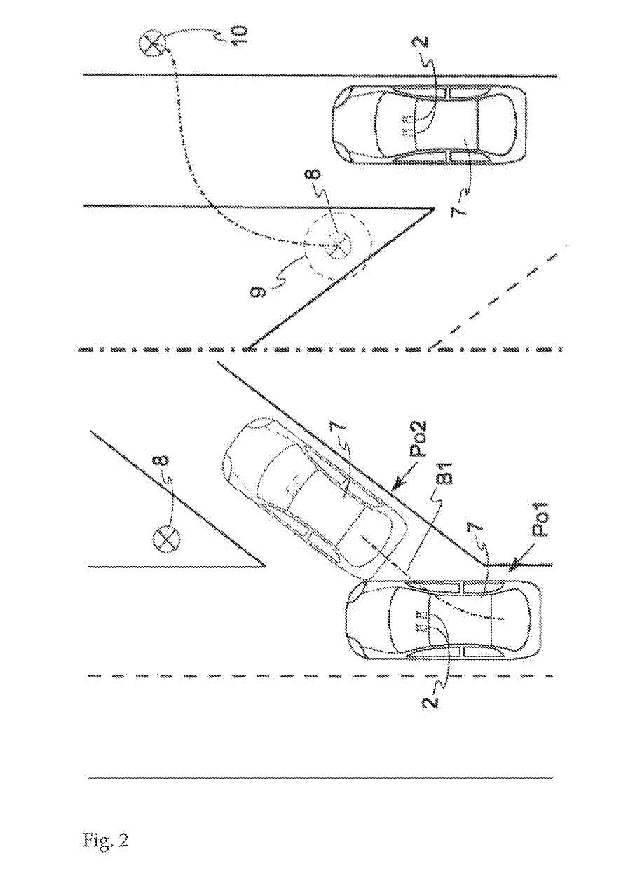

FIG. 2 shows a specific exemplary application of the method according to the invention in a typical driving situation.

FIG. 1 shows a schematic block diagram of an error detection device 6 according to the invention, which is configured to perform the method according to the invention. A system 1 can be seen, which has system variables Sx and/or with which system variables Sx lie in the perception or detection range of the motor vehicle system 1. The system 1 may be constituted by motor vehicles, such as cars or robots, in particular moving robots, aircraft, waterborne vessels or any other motorised technical systems for movement.

In the shown exemplary embodiment reference is made for visualisation to a motor vehicle of the error detection device 6 according to the invention illustrated in FIG. 1. The error detection device 6 here comprises two sensors 2 for the optical measurement of the vehicle surroundings. The sensors 2 measure a system variable S1, for example the position of an object, and send this information to a computing unit 3. Alternatively, the computing unit 3 could also request the information from the sensors 2; it is important that the information is made accessible to the computing unit 3 for processing. The computing unit 3 has access to a computing model 4, in which the vehicle properties are modelled and which is suitable, with the aid of past and/or current values of the system variable Sx or preferably a plurality of system variables Sx, for determining future values of the system variable(s) Sx, more specifically for determining one or more prediction value(s) Px. This/these prediction value(s) Px in principle constitute an anticipated value(s), wherein certain temporal rates of change of the system variable(s) Sx can be ruled out on account of physical limits and therefore criteria concerning admissible deviations between prediction value(s) Px associated with a moment in time t2 or a time interval Δt2 and the system variable(s) Sx associated with the moment in time t2 or the time interval Δt2 can be formulated. If these predefinable criteria are exceeded, a defective capture of the system variable(s) Sx can be concluded with high certainty, and consequently an error routine FR can be triggered. The error routine FR for example may stop the vehicle.

For an improved overview, a comparison device 5 is illustrated in FIG. 5, in which device the at least one prediction value Px is compared with the at least one system variable Sx. The comparison device 5 may be analogue or digital. The comparison device 5 may also form an integral part of the computing device 3.

With the aid of the error detection device 6 according to the invention or the method according to the invention, the plausibility of numerous measurement or calculation values can be checked. Distance sensors, radar sensors, optical sensors, ultrasound sensors, rotation rate sensors, pressure sensors, and the like can thus be checked. Individual sensors can also be substituted or supplemented. An unsteady wheel rotational speed, which for example may indicate a lack of traction of a vehicle located on a slippery ground, could also be detected by an insufficient relative movement of the vehicle surroundings (which for example is captured by cameras) compared with the rotational speed of a single wheel. A lack of tyre pressure in individual tyres could be captured on the basis of a tilt of the vehicle with respect to the vehicle ground. Generally, numerous system variables Sx can be captured and used to create a wide range of different prediction values Px. Thus, not only can error states be captured, but also verified with the aid of further system variables Sx. A slight inclined position of a vehicle captured by an optical measurement could indicate, for example, a low tyre pressure in a tyre, which for example can be verified by checking the deviation and/or change over time of the average wheel rotational speeds in relation to one another. A reduced tyre pressure in a tyre can therefore be determined even without measuring the tyre pressure.

FIG. 2 shows a specific exemplary application of the method according to the invention in a typical driving situation. A motor vehicle 7 which is moved from a first driving position Po1 into a second driving position Po2 along a movement path B1 illustrated schematical-ly by dashed lines can be seen in a left half of the image, which is separated from a right half of the image by a dot-and-dash line. The left half of FIG. 2 shows therein a perspective of an observer who is stationary with respect to the vehicle surroundings. The right half of the image by contrast shows the perspective of an observer who is located within the vehicle 7, the reference system of said observer therefore being linked in a stationary manner to the vehicle 7 and therefore can be moved jointly with the vehicle 7 relative to the vehicle surroundings. In the shown example the vehicle 7 has two sensors 2, which are formed as cameras and optically capture the vehicle surroundings. The sensors 2 in the shown example detect an object 8, which for example may be a streetlamp, i.e. a static obstacle. Alternatively, dynamic obstacles such as a moving person or vehicles could also be detected. The position of the streetlamps relative to the vehicle 7 is captured continu-ously. The vehicle 7 is located at the moment in time t1 in the position Po1, and the position of the object 8 is captured and stored as system variable S1. If the vehicle now moves into position Po2, the position of the vehicle 7 relative to the object 8 thus changes, as illustrated in the right-hand half of FIG. 2. A computing model 4 calculates a prediction value Px for the system variable S1 (in this example the system variable S1 corresponds to the system variable Sx) on the basis of a determined steering angle, the wheel rotational speeds and/or the movement of the vehicle relative to the vehicle surroundings, and the prediction value in this example corresponds to an expected value for the position of the object 8 relative to the vehicle 7 at the moment in time t2. This expected value is repre-sented by the field 9. If the object lies within the field 9, it can be concluded that the optical measurement of the system variable S1 has been performed correctly at the moments in time t1 and t2. This is the case in the present example. If the object 8, however, were still in the position indicated by reference sign 10, the comparison of the system variable Sx (i.e. of the variable S1 at the moment in time t2) with the prediction value Px would thus lead to the result that there is an error present. Here, depending on the amount of available information, the error either can be merely determined as such or can even be corrected, and the defective information source identified. In the shown example the images of the two cameras could be compared with one another. If, on account of an error in the data processing, one of the two cameras also reproduces at the moment in time t2 a recording associated with the moment in time t1, for example because a data memory is overfull or a data processing error has led to an endless loop, this deviation can be determined by the second camera and verified by a comparison with the computing model. The software/hardware of the defective camera could thus be restarted in order to remedy the error. Should the error not be remedied as a result, an error display can be activated and the vehicle 7 in some circumstances can still be safely operated if sufficiently redundant information sources ensure a reliable capture of relevant system variables S1, such as the position of objects 8. The vehicle 7 in such a scenario would remain ready for operation without limitation, and the defective camera could be replaced, for example during the course of an annual vehicle check. The detectable errors may therefore be of a completely different nature and may be based on a comparison of at least one optically detected measurement value of a system variable S1 (for example the position of the object 8) or a value, traceable thereto, of a system variable Sx (for example the size or distance from the object 8) with a prediction value output by a computing model, in particular a vehicle model, which a priori applies knowledge (for example concerning the vehicle physics) to the variables S1 and/or Sx captured at the moment in time t1 and from this creates a prediction value Px associated with the moment in time t2, which prediction value is compared with a value of the system variable Sx associated with the moment in time t2, and the result of the comparison is used to determine the presence of at least one error. The error can be caused here in principle by a defective hardware for optical measurement of the system variable S1, by defective software, by defective capture of other system variables Sx, or also by a defective computing model, wherein the latter can be prevented by careful selection and programming of the computing model.

Since the invention described within the scope of this description can be used in a versatile manner, not all possible fields of application can be described in detail. Rather, a person skilled in the art, under consideration of these embodiments, is able to use and adapt the invention for a wide range of different purposes. The technical structure of the described error detection system 6 therefore is not limited to the presented embodiments.

1. A method for error detection for a motor vehicle system (1), the method comprising:
a) at least partially optically measuring at least one system variable S1 at least at one moment in time t1 or at least in a time interval Δt1;
b) creating at least one prediction value Px for at least one system variable Sx for at least one moment in time t2 following the moment in time t1 or for at least one time interval Δt2 following the time interval Δt1 with the aid of at least one computing model (4) under consideration of the at least one system variable S1;
c) comparing the at least one prediction value Px with at least one value of the at least one system variable Sx associated with the moment in time t2 or the time interval Δt2; and
d) using the result of the comparison of step c) to determine the presence of at least one error.

2. The method of claim 1, wherein after step a) and before step b) the optical measurement performed in step a) is processed in the at least one computing model (4) or in at least one further computing model.

3. The method of claim 1, wherein the at least one value of the at least one system variable Sx associated with the moment in time t2 or the time interval Δt2 is determined in step c) by a measurement.

4. The method of claim 1, wherein the least one value of the at least one system variable Sx associated with the moment in time t2 or the time interval Δt2 is determined in step c) by a calculation.

5. The method of claim 1, wherein the at least one system variable Sx comprises the system variable S1.

6. The method of claim 1, wherein the at least one system variable Sx comprises a system variable S2 that is different from the system variable S1.

7. The method of claim 1, wherein the at least one system variable Sx comprises a position variable, an orientation variable, colour information, a speed variable, an acceleration variable, contrast and/or sharpness information and/or a pressure variable.

8. The method of claim 1, wherein a series of images is generated in step a) or b), from which relevant image features are extracted by means of image processing algorithms, with the aid of which image features the at least one system variable Sx is captured and/or predicted.

9. The method of claim 1, wherein images are generated in step a) from different perspectives, from which relevant image features are extracted by means of image processing algorithms, with the aid of which image features the at least one system variable Sx is captured and/or predicted.

10. The method of claim 9, wherein coordinates of the relevant image features are extracted from the images by means of image processing algorithms and the at least one system variable Sx is captured and/or predicted with the aid of the temporal course of these coordinates.

11. The method of claim 1, wherein a series of images is generated in step a), from which coordinates of relevant image features are extracted by means of image processing algorithms, and the at least one system variable Sx is captured and/or predicted with the aid of the temporal course of these coordinates.

12. The method of claim 1, wherein in step a) the measurement is performed with the aid of at least two mutually distanced optical sensors (2).

13. The method of claim 1, wherein an error routine (FR) is triggered in the presence of at least one error.

14. The method of claim 1, wherein the computing model (4) is a vehicle computing model.

15. The method of claim 14, wherein the vehicle computing model is a one-track model or a two-track model.

16. An error detection device (6) for at least one motor vehicle system (1), the device (6) comprising:
at least one sensor (2) that is configured for the optical measurement of at least one system variable S1 at least at one moment in time t1 or at least at a time interval Δt1; and
at least one computing device (3) that is configured to process at least the optical measurement performed and to create at least one prediction value Px for at least one system variable Sx for at least one moment in time t2 following the moment in time t1 or for at least one time interval Δt2 following the time interval Δt1 with the aid of the at least one computing model (4),
wherein the at least one computing device (3) or at least one comparison device (5) is configured to compare the at least one prediction value Px with at least one value of the at least one system variable Sx associated with the moment in time t2 or the time interval Δt2, and
wherein the at least one computing device (3) or the at least one comparison device (5) uses the result of the comparison to determine the presence of at least one error.

17. The error detection device (6) of claim 16, wherein the at least one computing device (3), in order to process at least the optical measurement performed, additionally processes the optical measurement in the at least one computing model (4) or in a further at least one computing model.

18. The error detection device (6) of claim 16, wherein at least one measuring device measures the at least one value of the at least one system variable Sx associated with the moment in time t2 or the time interval Δt2.

19. The error detection device (6) of claim 16, wherein the at least one computing device (3) calculates the at least one value of the at least one system variable Sx associated with the moment in time t2 or the time interval Δt2.

20. The error detection device (6) of claim 16, wherein the at least one system variable Sx comprises the system variable S1.

21. The error detection device (6) of claim 16, wherein the at least one system variable Sx comprises a system variable S2 that is different from the system variable S1.

22. The error detection device (6) of claim 16, wherein the at least one system variable Sx comprises a position variable, an orientation variable, colour information, a speed variable, an acceleration variable, contrast and/or sharpness information and/or a pressure variable.

23. The error detection device (6) of claim 16, wherein the at least one computing device (3) generates a series of images, extracts relevant image feature by means of image processing algorithms, and captures and/or predicts the at least one system variable Sx with the aid of the image features.

24. The error detection device (6) of claim 16, wherein the at least one computing device (3) generates images from different perspectives, extracts relevant image features by means of image processing algorithms, and captures and/or predicts the at least one system variable Sx with the aid of the image features.

25. The error detection device of claim 24, wherein the at least one computing device (3) extracts coordinates of the relevant image features from the images by means of image processing algorithms and captures and/or predicts the at least one system variable Sx with the aid of the temporal course of these coordinates.

26. The error detection device (6) of claim 16, wherein at least one computing device (3) generates a series of images, extracts coordinates of relevant image features by means of image processing algorithms, and captures and/or predicts the at least one system variable Sx with the aid of the temporal course of these coordinates.

27. The error detection device (6) of claim 16, comprising at least two mutually distanced optical sensors (2).

28. The error detection device (6) of claim 16, wherein the computing model is a vehicle computing model.

29. The error detection device (6) of claim 28, wherein the vehicle computing model is a one-track model or a two-track model.

30. A motor vehicle comprising at least one error detection device (6) of claim 16.
